(19) United States
(12) Patent Application Publication
(10) Pub. No.: US 2012/0118869 A1
(43) Pub. Date: May 17, 2012

(54) DIRECT APPLICATION AUTOMOTIVE STEERING WHEEL HEATER

(75) Inventors: Darrel Burton Saunders, Windsor (CA); Robert Charles Echlin, Windsor (CA)

(73) Assignee: NORTH AMERICAN RESCUE, LLC, Greer, SC (US)

(21) Appl. No.: 13/387,184

(22) PCT Filed: Aug. 6, 2010
(86) PCT No.: PCT/US2010/002183

§ 371 Date: Jan. 26, 2012

Related U.S. Application Data
(60) Provisional application No. 61/231,767, filed on Aug. 6, 2009.

(51) Int. Cl. B60L 1/02; B29C 45/14

(52) U.S. Cl. 219/204; 264/104

(57) ABSTRACT

A primary support member defining a general shape of the steering wheel. A rigid over-molding layer generally encasing said primary support member. An electrically resistive layer disposed on said over-molding layer for being energized to create a heat source on the steering wheel. A first electrically conductive strip applied to said electrically resistive layer defining a positive electrical connection to said electrically resistive layer. A second electrically conductive strip applied to said electrically resistive layer defining a negative electrical connection to said electrically resistive layer. A dielectric layer encasing said electrically resistive layer and said first and second electrically conductive strips for insulation. A finishing cover layer applied over said dielectric layer generally encasing said dielectric layer.

### CROSS REFERENCE TO RELATED APPLICATION

This application claims priority from provisional application filed Aug. 6, 2009 under Application No. 61/231,767.

### BACKGROUND OF THE INVENTION

1) Field of the Invention

The present invention relates generally to the field of heater assemblies, and more particularly, this disclosure relates to a steering wheel heater assembly and method of making such an assembly for heating a steering wheel.

2) Description of Related Art

A conventional steering wheel is constructed of a cast magnesium armature or the like that is subsequently over-molded with a urethane foam (or other similarly appropriate material) for covering the magnesium armature and for providing an appropriately useful steering wheel assembly. A heating element is then placed around the steering wheel. A cover is then provided over the steering wheel heater assembly. In one application, a closed cell foam or urethane rubber backed leather cover is applied over the armature and the heater assembly and then sewn in place. Conventional steering wheel heaters are premised on generally round wire based technology having a current passing there through to cause the wire element to emit heat. Such traditional heater elements provide inconsistent heat coverage and lower comfort, use a significant amount of power, and are overly susceptible to damage through repetitive use over time.

There remains a significant and long-continuing need to provide an improved steering wheel heater assembly that provides greater performance and competitive advantages over known steering wheel heater assemblies.

Accordingly, it is an object of the present invention to construct an improved steering wheel heater that provides consistent heat coverage and comfort, requires less power, has greater strength and resistance to damage, has a longer lifespan, and provides a means to selectively adjust the temperature of specific areas of the steering wheel.

### SUMMARY OF THE INVENTION

The above objectives are accomplished according to the present invention by providing a heated steering wheel assembly, comprising a primary support member defining a general shape of the steering wheel; a rigid over-molding layer generally encasing the primary support member; an electrically resistive layer disposed on the over-molding layer for being energized to create a heat source on the steering wheel; a first electrically conductive strip applied to the electrically resistive layer defining a positive electrical connection to the electrically resistive layer; a second electrically conductive strip applied to the electrically resistive layer defining a negative electrical connection to the electrically resistive layer; a dielectric layer encasing the electrically resistive layer and the first and second electrically conductive strips for insulation; and, a finishing cover layer applied over the dielectric layer generally encasing the dielectric layer.

In one embodiment, the primary support member is a magnesium armature.

In one embodiment, the rigid over-molding layer consists of a urethane foam.

In one embodiment, the electrically resistive layer includes a paste selected from the group consisting of carbon, graphite, or a blend thereof, which is cured to the rigid over-molding layer.

In one embodiment, the paste includes a plasticized base allowing for flexing.

In one embodiment, the electrically resistive layer has a conductivity in the range of 60-100 ohms for a given square surface area.

In one embodiment, a ridge line is included extending around the length of the rigid over-molding layer.

In one embodiment, the ridge line defines a gap in the electrically resistive layer applied around the length of the rigid over-molding layer.

In one embodiment, the first and second electrically conductive strips are disposed adjacent to and on opposite sides of the ridge line.

In one embodiment, the first and second electrically conductive strips are spaced apart approximately in the range of 2-6 mm with the ridge line disposed generally at a midpoint between the first electrically conductive strip and the second electrically conductive strip.

In one embodiment, the first and second electrically conductive strips extend generally parallel to each other along the length of the electrically resistive layer around the steering wheel.

In one embodiment, the first and second electrically conductive strips consist of a silver based coating.

In one embodiment, the primary support member includes a groove running the length of the support member for receiving the rigid over-molding layer to resist rotation of the over-molding layer around the support member.

In one embodiment, a stitching channel is included extending around at least a portion of a circumference of the over-molding layer.

In one embodiment, the first and second electrically conductive strips extend into the stitching channel, and a plurality of electrical wire connectors disposed in the stitching channel engaging each of the electrically conductive strips.

In one embodiment, the electrical wire connectors include at least one prong extending into the rigid over-molding layer and a base running across at least a portion of one of the first and second electrically conductive strips.

In one embodiment, a third electrically conductive strip is applied to the electrically resistive layer defining a positive electrical connection to the electrically resistive layer.

The above objectives are further accomplished according to the present invention by providing a method for forming a heated steering wheel assembly, comprising the steps of providing a primary support member defining a general shape of the steering wheel; applying a rigid over-molding layer generally encasing the primary support member; applying an electrically resistive layer disposed on the over-molding layer for being energized to create a heat source on the steering wheel; applying a first electrically conductive strip to the electrically resistive layer defining a positive electrical connection to the electrically resistive layer; applying a second electrically conductive strip to the electrically resistive layer defining a negative electrical connection to the electrically resistive layer; applying a dielectric layer encasing the electrically resistive layer and the first and second electrically conductive strips for insulation; and, applying a finishing cover layer over the dielectric layer generally encasing the dielectric layer.

In a further embodiment, the method includes the step of forming a ridge line extending around the length of the rigid over-molding layer which defines a gap in the electrically resistive layer applied around the length of the rigid over-molding layer.

In a further embodiment, the method includes the step of applying the first and second electrically conductive strips adjacent to and on opposite sides of the ridge line, and spacing the electrically conductive strips apart approximately in the range of 2-6 mm with the ridge line disposed generally at a midpoint between the first electrically conductive strip and the second electrically conductive strip.

### BRIEF DESCRIPTION OF THE DRAWINGS

The construction designed to carry out the invention will hereinafter be described, together with other features thereof, The invention will be more readily understood from a reading of the following specification and by reference to the accompanying drawings forming a part thereof, wherein an example of the invention is shown and wherein:

FIG. 1 shows a perspective view of a vehicle having a steering wheel assembly according to an exemplary embodiment of the present invention;

FIG. 2 shows a front view of a steering wheel for a vehicle according to an exemplary embodiment of the present invention;

FIG. 3 shows a typical cross sectional view of an automotive steering wheel in the prior art;

FIG. 4 shows a cross-sectional view of one embodiment of a steering wheel having a steering wheel heater according to an exemplary embodiment of the present invention;

FIG. 5A shows a side cut-away section view of one embodiment of a steering wheel having a steering wheel heater according to an exemplary embodiment of the present invention;

FIG. 5B shows a cross-sectional view of one embodiment of a steering wheel having a steering wheel heater according to an exemplary embodiment of the present invention; and,

FIG. 5C shows a cross-sectional view of one embodiment of a steering wheel having a steering wheel heater according to an exemplary embodiment of the present invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail,

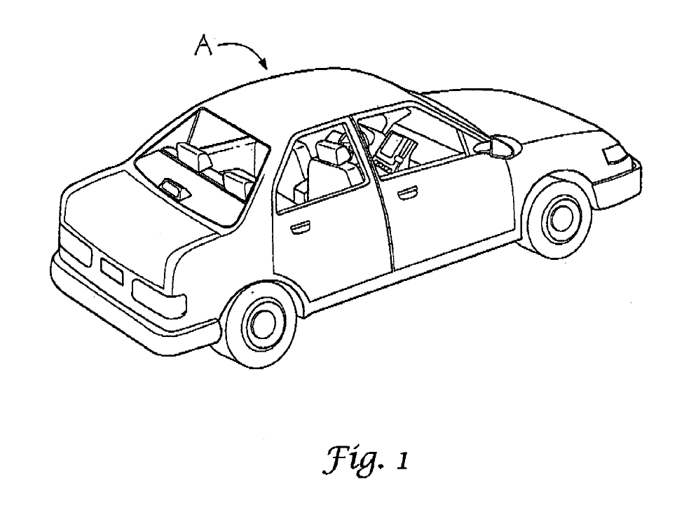

Referring generally to the figures and in particular to FIG. 1, a vehicle (A) is shown according to an exemplary embodiment. The vehicle includes, among other things, a steering wheel.

FIG. 2 shows a steering wheel assembly (B) for a vehicle, according to an exemplary embodiment. The steering wheel is constructed in the form of a circular ring, but may take any number of different shapes. In the illustrated embodiment, a plurality of spokes (C) extend from the inner ring surface area to the epicenter of the ring. The outer surface area of the steering wheel is covered with a material that enhances the grip and comfort of the vehicle operator, for example, leather.

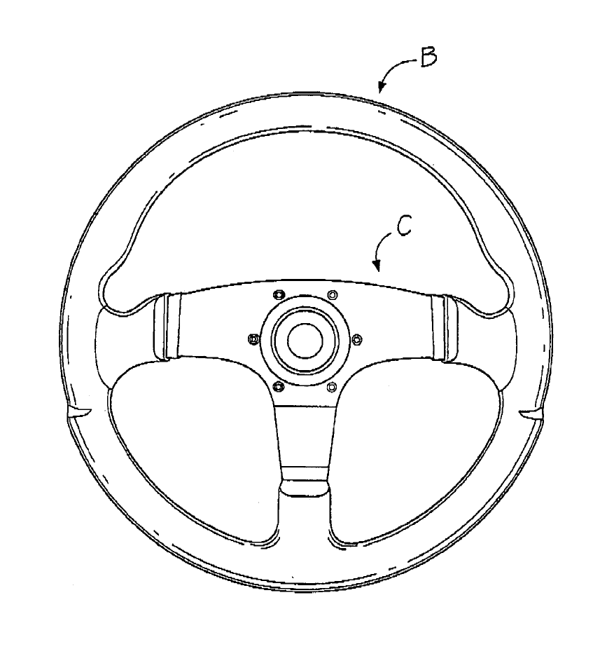

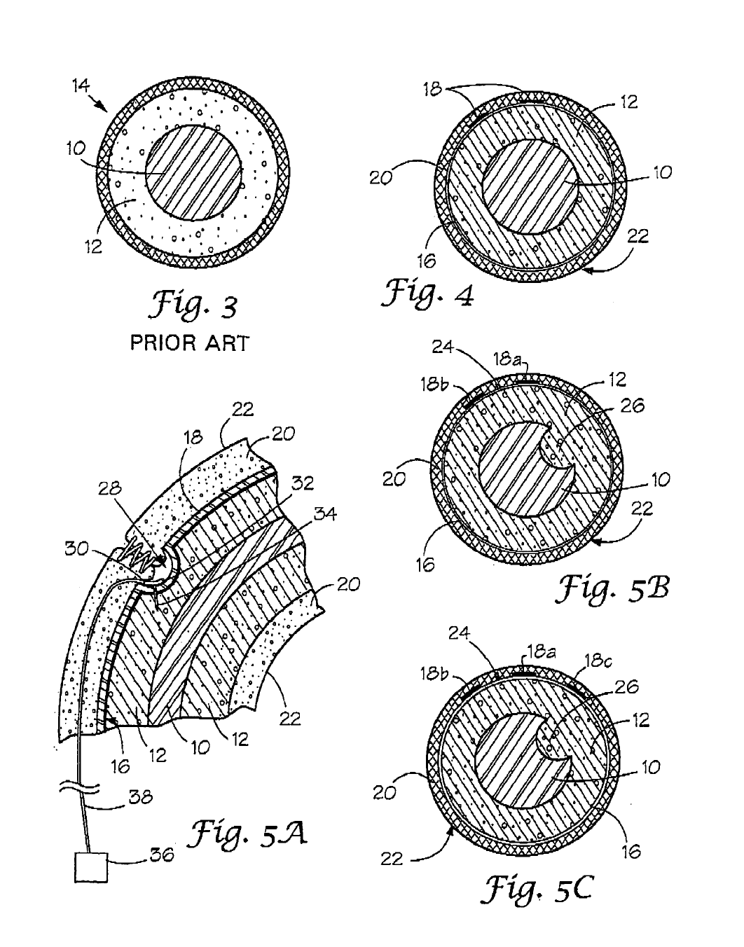

Referring now to FIG. 3, an enlarged cross-sectional view of the steering wheel assembly is shown. As previously described a conventional steering wheel is constructed of a cast magnesium armature 10 or the like that is subsequently over-molded with a urethane foam 12 (or other similarly appropriate material) for covering the magnesium armature and for providing an appropriately useful steering wheel assembly. Applied to the over-molded material is a layer of electrically conductive wire mesh sewn into a cover 14, for example, a closed cell foam or neoprene rubber backed leather cover. The cover is then sewn together around the wheel to be held in place.

Referring now to FIG. 4, an enlarged cross-sectional view of the steering wheel heater assembly is shown. The steering wheel is constructed with a primary support member that forms the frame work for building outward therefrom. In the illustrated embodiment, the primary support member is a cast magnesium armature 10 that is bound by a rigid over-molding layer, which in the preferred embodiment, is a urethane foam 12 (or other similarly appropriate material). A layer of electrically resistive paste 16 is applied over the surface of the urethane cover areas of the wheel assembly. An intermittent layer in the form of a plurality of strips 18 or minor lines of electrically conductive paste is applied over the electrically resistive layer. Over the entire area that has been coated with resistive paste and the electrically conductive strips, a final layer of dielectric sealant 20 is applied. Finally, a finishing cover 22, for example, a neoprene lined leather cover is sewn into place to cover the wheel.

The over-molding layer 12 of urethane foam (or other similarly appropriate material) is for reference and is one of the industry standard methods of constructing a steering wheel. A ridge line 24 (FIGS. 5B and 5C) is formed in the foam extending around the length of the rigid over-molding layer 12. Typically this results from the molding process of forming the over-molding layer around support member 10. In a preferred embodiment shown in FIGS. 5B and 5C, primary support member 10 includes a groove 26 running the length of said support member 10 for receiving the rigid over-molding layer 12 to resist rotation of over-molding layer 12 around support member 10.

The electrically resistive layer 16 is preferably a carbon, graphite or a blend of the afore said that has a pre-determined fixed surface resistivity. The layer begins as a paste or ink (eg. Electra Polymers ED-4000 resistive paste) that is applied to the urethane layer 12 by way of a controlled application. The paste or ink must be of a plasticized base that allows for extreme flexing. The method of application may be but not restricted to silk screening, spraying or submersion bath. After application this layer is cured or dried to the urethane. The heating or drying also causes the softening of the urethane which allows for the resistive paste to fully bond to the surface. A particular characteristic with this printed carbon technology is that there is a direct correlation between input voltage and output temperature. In other words, as long as voltage X is constant, wattage Y will also remain constant so temperature will reach a peak and remain there. Preferably, in this application, the electrically resistive layer has a conductivity in the range of 60-100 ohms for a given square surface area.

Next, a plurality of strips 18 in the form of an electrically conductive paste or polymer based silver coating (eg. Coates E8205) is applied to act as positive 18a and negative 18b power feeds. This plasticized paste has a high level of conductivity and is applied in positions to best supply power to the entire surface of the resistive paste. This layer may be two or more conductors in a pattern (redundancy in silver supply leads) that best suits the design and the power draw considerations for the complete heater. This layer is applied by way of silk screen or spray application. After application this layer is cured or dried to the resistive layer.

In the illustrated embodiment, the ridge line 24 defines a gap in the electrically resistive layer 16 applied around the length of the rigid over-molding layer 12. The first and second electrically conductive strips 18a and 18b are disposed adjacent to and on opposite sides of the ridge line 24. Preferably, the first and second electrically conductive strips 18a and 18b are spaced apart approximately in the range of 2-6 mm with the ridge line 24 disposed generally at a midpoint between the first electrically conductive strip 18a and the second electrically conductive strip 18b. Preferably, first and second electrically conductive strips 18a and 18b extend generally parallel to each other along the length of said electrically resistive layer 16 around the steering wheel.

The dielectric layer 20 acts as an electrical insulator along with protecting the surface of the heater from moisture or other contaminants during its life. The dielectric is a paste or ink (eg. Electra Polymers ED8040) than can be applied by way of silk screening, spray or submersion.

Finally, the finishing cover 22 is attached around the wheel. In a preferred embodiment, the industry standard neoprene lined leather cover can be sewn in place.

Referring to FIG. 5A, in a preferred embodiment, a stitching channel 28 is provided that extends around at least a portion of a circumference of over-molding layer. This is provided to accommodate a bulk of material when the finishing cover is stitched together and provide a smooth finish around the wheel. The first and second electrically conductive strips extend into the stitching channel 28 as they are applied around the wheel, A plurality of electrical wire connectors 30 are disposed in the stitching channel 28 engaging each of electrically conductive strips 18a and 18b. The electrical wire connectors include at least one prong 32 extending into rigid over-molding layer 12 and a base 34 running across at least a portion of one of first and second electrically conductive strips 18a and 18b. A wire harness 36 is coupled to the electrical wire connectors 30 at predetermined locations along the plurality of positive and negative conductors 18a and 18b, preferably in stitching channel 28 by an arrangement of electrical wires 38. This harness 36 will then be attached to a vehicle power supply.

According to an alternate embodiment, a third electrically conductive strip 18c (FIG. 5C) is applied to the electrically resistive layer 16 defining a positive electrical connection to the electrically resistive layer. This provides the ability for a double temperature control system to be incorporated into the heater system. The control system includes an ultra-thin thermostat (e.g., PEPI Control System, etc.) inserted into the backside of a spoke of the steering wheel (not shown). The double temperature control system enables regulation of the steering wheel temperature within about 1° C. By incorporating a third electrically conductive strip 18c, the radius between the positive and negative couplings can be reduced. This results in less resistance from electrically resistive layer 16 and thus an increased temperature. By selecting between positive electrical strips 18a and 18c to interact with negative strip 18b, the operational radius of the electrically resistive layer is altered and the temperature increased or decreased accordingly.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

It is also important to note that the construction and arrangement of the elements of the steering wheel as shown in the preferred and other exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present innovations. Other substitutions, modifications, changes and omissions may be made in the design, operating conditions and arrangement of the preferred and other exemplary embodiments without departing from the spirit of the present innovations.

What is claimed is:

1. A heated steering wheel assembly, comprising:
a primary support member defining a general shape of the steering wheel;
a rigid over-molding layer generally encasing said primary support member;
an electrically resistive layer disposed on said over-molding layer for being energized to create a heat source on the steering wheel;
a first electrically conductive strip applied to said electrically resistive layer defining a positive electrical connection to said electrically resistive layer;
a second electrically conductive strip applied to said electrically resistive layer defining a negative electrical connection to said electrically resistive layer;
a dielectric layer encasing said electrically resistive layer and said first and second electrically conductive strips for insulation; and,
a finishing cover layer applied over said dielectric layer generally encasing said dielectric layer.

2. The steering wheel assembly of claim 1 wherein said primary support member is a magnesium armature.

3. The steering wheel assembly of claim 1 wherein said rigid over-molding layer consists of a urethane foam.

4. The steering wheel assembly of claim 1 wherein said electrically resistive layer includes a paste selected from the group consisting of carbon, graphite, or a blend thereof, which is cured to said rigid over-molding layer.

5. The steering wheel assembly of claim 4 wherein said paste includes a plasticized base allowing for flexing.

6. The steering wheel assembly of claim 1 wherein said electrically resistive layer has a conductivity in the range of 60-100 ohms for a given square surface area.

7. The steering wheel assembly of claim 1 including a ridge line extending around the length of said rigid over-molding layer.

8. The steering wheel assembly of claim 7 wherein said ridge line defines a gap in said electrically resistive layer applied around the length of said rigid over-molding layer.

9. The steering wheel assembly of claim 7 wherein said first and second electrically conductive strips are disposed adjacent to and on opposite sides of said ridge line.

10. The steering wheel assembly of claim 9 wherein said first and second electrically conductive strips are spaced apart approximately in the range of 2-6 mm with said ridge line disposed generally at a midpoint between said first electrically conductive strip and said second electrically conductive strip.

11. The steering wheel assembly of claim 1 wherein said first and second electrically conductive strips extend generally parallel to each other along the length of said electrically resistive layer around the steering wheel.

12. The steering wheel assembly of claim 1 wherein said first and second electrically conductive strips consist of a silver based coating.

13. The steering wheel assembly of claim 1 wherein said primary support member includes a groove running the length of said support member for receiving said rigid over-molding layer to resist rotation of said over-molding layer around said support member.

14. The steering wheel assembly of claim 1 including a stitching channel extending around at least a portion of a circumference of said over-molding layer.

15. The steering wheel assembly of claim 14 wherein said first and second electrically conductive strips extend into said stitching channel, and a plurality of electrical wire connectors disposed in said stitching channel engaging each of said electrically conductive strips.

16. The steering wheel assembly of claim 15 wherein said electrical wire connectors include at least one prong extending into said rigid over-molding layer and a base running across at least a portion of one of said first and second electrically conductive strips.

17. The steering wheel assembly of claim 1 including a third electrically conductive strip applied to said electrically resistive layer defining a positive electrical connection to said electrically resistive layer.

18. A method for forming a heated steering wheel assembly, comprising the steps of:
providing a primary support member defining a general shape of the steering wheel;
applying a rigid over-molding layer generally encasing said primary support member;
applying an electrically resistive layer disposed on said over-molding layer for being energized to create a heat source on the steering wheel;
applying a first electrically conductive strip to said electrically resistive layer defining a positive electrical connection to said electrically resistive layer;
applying a second electrically conductive strip to said electrically resistive layer defining a negative electrical connection to said electrically resistive layer;
applying a dielectric layer encasing said electrically resistive layer and said first and second electrically conductive strips for insulation; and,
applying a finishing cover layer over said dielectric layer generally encasing said dielectric layer.

19. The method of claim 18 including the step of forming a ridge line extending around the length of said rigid over-molding layer which defines a gap in said electrically resistive layer applied around the length of said rigid over-molding layer.

20. The method of claim 19 including the step of applying said first and second electrically conductive strips adjacent to and on opposite sides of said ridge line, and spacing said electrically conductive strips apart approximately in the range of 2-6 mm with said ridge line disposed generally at a midpoint between said first electrically conductive strip and said second electrically conductive strip.
